(19) United States
(12) Patent Application Publication
(10) Pub. No.: US 2018/0182399 A1
(43) Pub. Date: Jun. 28, 2018

(54) CONTROL METHOD FOR CONTROL DEVICE, CONTROL METHOD FOR APPARATUS CONTROL SYSTEM, AND CONTROL DEVICE

(71) Applicant: YAMAHA CORPORATION, Hamamatsu-shi (JP)

(72) Inventors: Akihiko SUYAMA, Hamamatsu-shi (JP); Katsuaki TANAKA, Hamamatsu-shi (JP)

(21) Appl. No.: 15/903,436

(22) Filed: Feb. 23, 2018

Related U.S. Application Data
(63) Continuation of application No. PCT/JP2016/085976, filed on Dec. 2, 2016.

(51) Int. Cl. G10L 17/00; G10L 15/07; G10L 15/32; G10L 15/30; G10L 15/02; G10L 15/26; G10L 15/22

(52) U.S. Cl. CPC G10L 17/005; G10L 15/07; G10L 15/32; G10L 15/30; G10L 2015/227; G10L 15/265; G10L 15/22; H04M 2201/405; G10L 15/02

(57) ABSTRACT

Provided is a control method for a control device including: acquiring a user instruction to control a control target apparatus by a user, generating control speech information in response to the user instruction, the control speech information being speech information representing content of control on the control target apparatus and including auxiliary speech information which is different information from the user instruction, and outputting the generated control speech information to a speech recognition server which executes speech recognition processing.

### CROSS-REFERENCE TO RELATED APPLICATION

The present application is continuation of International Application No. PCT/JP2016/085976 filed on Dec. 2, 2016. The contents of the application are hereby incorporated by reference into this application.

### BACKGROUND OF THE INVENTION

### 1. Field of the Invention

The present invention relates to a control device and an apparatus control system.

### 2. Description of the Related Art

An apparatus control system which performs speech recognition of a speech uttered by a user and thus controls a control target apparatus (for example, a TV or audio apparatus or the like) is known (see, for example, JP2014-78007A, JP2016-501391T, and JP2011-232521A). Such an apparatus control system generates a control command to cause a control target apparatus to operate, from a speech uttered by a user, using a speech recognition server which executes speech recognition processing.

### SUMMARY OF THE INVENTION

When controlling an apparatus using a speech recognition server as described above, the user must utter the designation of a control target apparatus to be controlled and the content of control every single time. Thus, it is envisaged that an ability to control a control target apparatus without the user having to utter all of the designation of the control target apparatus and the content of control improves convenience for the user. For example, if the user can omit the designation of a control target apparatus in the case where the user always causes the same control target apparatus to operate, this can reduce the amount of utterance by the user and therefore improves convenience for the user. Also, if the user can cause the control target apparatus to operate without utterance in circumstances where the user cannot utter anything, this improves convenience for the user.

In order to solve the foregoing problem, an object of the invention is to provide a control device and an apparatus control system which control an apparatus, using a speech recognition server, and which can control a control target apparatus without the user having to utter all of the content of control.

In order to solve the foregoing problem, a control device according to the invention includes: a user instruction acquisition unit which acquires a user instruction to control a control target apparatus by a user; a control speech information generation unit which generates control speech information in response to the user instruction, the control speech information being speech information representing content of control on the control target apparatus and including auxiliary speech information which is different information from the user instruction; and a control speech information output unit which outputs the generated control speech information to a speech recognition server which executes speech recognition processing.

An apparatus control system according to the invention includes a first control device, a second control device, and a control target apparatus. The first control device includes: a user instruction acquisition unit which acquires a user instruction to control the control target apparatus by a user; a control speech information generation unit which generates control speech information in response to the user instruction, the control speech information being speech information representing content of control on the control target apparatus and including auxiliary speech information which is different information from the user instruction; and a control speech information output unit which outputs the generated control speech information to a speech recognition server which executes speech recognition processing. The second control device includes: a control command generation unit which generates a control command to cause the control target apparatus to operate, based on a result of recognition in the speech recognition processing executed by the speech recognition server; and an apparatus control unit which controls the control target apparatus according to the control command.

A control method for a control device according to the invention includes: acquiring a user instruction to control a control target apparatus by a user; generating control speech information in response to the user instruction, the control speech information being speech information representing content of control on the control target apparatus and including auxiliary speech information which is different information from the user instruction; and outputting the generated control speech information to a speech recognition server which executes speech recognition processing.

### BRIEF DESCRIPTION OF THE DRAWINGS

FIG. 1 shows an example of the overall configuration of an apparatus control system according to a first embodiment of the invention.

FIG. 2 is a functional block diagram showing an example of functions executed by a first control device, a second control device, and a speech recognition server according to the first embodiment.

FIG. 3 shows an example of association information according to the first embodiment.

FIG. 4 is a sequence chart showing an example of processing executed by the apparatus control system according to the first embodiment.

FIG. 5 is a functional block diagram showing an example of functions executed by a first control device, a second control device, and a speech recognition server according to a first example of a second embodiment.

FIG. 6 shows an example of an operation instruction screen displayed on a display unit of the first control device.

FIG. 7 shows an example of an auxiliary speech information storage unit according to the second embodiment.

FIG. 8 is a functional block diagram showing an example of functions executed by a first control device, a second control device, and a speech recognition server according to a second example of the second embodiment.

FIG. 9 is a sequence chart showing an example of processing executed by an apparatus control system according to the second example of the second embodiment.

FIG. 10 is a functional block diagram showing an example of functions executed by the first control device, the second control device, and the speech recognition server according to the first embodiment.

FIG. 11 is a functional block diagram showing an example of functions executed by the first control device, the second control device, and the speech recognition server according to the second embodiment.

### DETAILED DESCRIPTION OF THE INVENTION

Embodiments of the invention will be described below with reference to the drawings. In the drawings, identical or equivalent components are denoted by the same reference signs and are not described repeatedly.

### First Embodiment

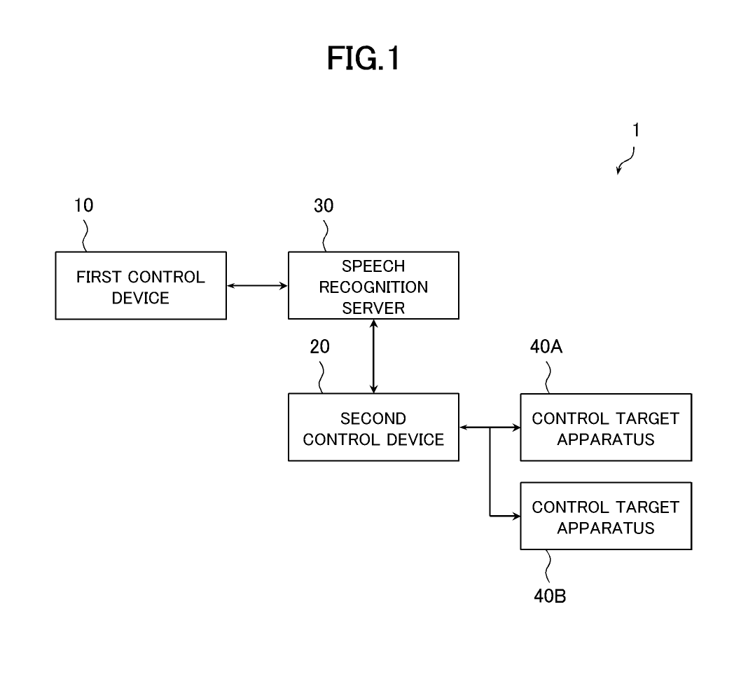

FIG. 1 shows an example of the overall configuration of the apparatus control system 1 according to a first embodiment of the invention. As shown in FIG. 1, the apparatus control system 1 according to the first embodiment includes a first control device 10, a second control device 20, a speech recognition server 30, and a control target apparatus 40 (control target apparatus 40A, control target apparatus 40B). The first control device 10, the second control device 20, the speech recognition server 30, and the control target apparatus 40 are connected to a communication measure such as a LAN or the internet so as to communicate with each other.

The first control device 10 (equivalent to an example of the control device according to the invention) is a device which accepts various instructions from a user to control the control target apparatus 40. The first control device 10 is implemented, for example, by a smartphone, tablet, personal computer or the like. The first control device 10 is not limited to such a general-purpose device and may be implemented as a dedicated device. The first control device 10 includes: a control unit which is a program control device such as a CPU operating according to a program installed in the first control device 10; a storage unit which is a storage element like a ROM or RAM, or a hard disk drive or the like; a communication unit which is a communication interface such as a network board; an operation unit which accepts an operation input by the user; and a sound collection unit which is a microphone unit for collecting a speech uttered by the user.

The second control device 20 is a device for controlling the control target apparatus 40 and is implemented, for example, by a cloud server or the like. The second control device 20 includes: a control unit which is a program control device such as a CPU operating according to a program installed in the second control device 20; a storage unit which is a storage element like a ROM or RAM, or a hard disk drive or the like; and a communication unit which is a communication interface such as a network board.

The speech recognition server 30 is a device which executes speech recognition processing and is implemented, for example, by a cloud server or the like. The speech recognition server 30 includes a control unit which is a program control device such as a CPU which operates according to a program installed in the speech recognition server 30; a storage unit which is a storage element like a ROM or RAM, or a hard disk drive or the like; and a communication unit which is a communication interface such as a network board.

The control target apparatus 40 is a device that is a target to be controlled by the user. The control target apparatus 40 is, for example, an audio apparatus or audio-visual apparatus and carries out playback of content (audio or video) or the like in response to an instruction from the user. The control target apparatus 40 is not limited to an audio apparatus or audio-visual apparatus and may be an apparatus used for other purposes such as an illumination apparatus. Although FIG. 1 shows that two control target apparatuses 40 (control target apparatus 40A, control target apparatus 40B) are included in the system, three or more control target apparatuses 40 may be included, or one control target apparatus 40 may be included.

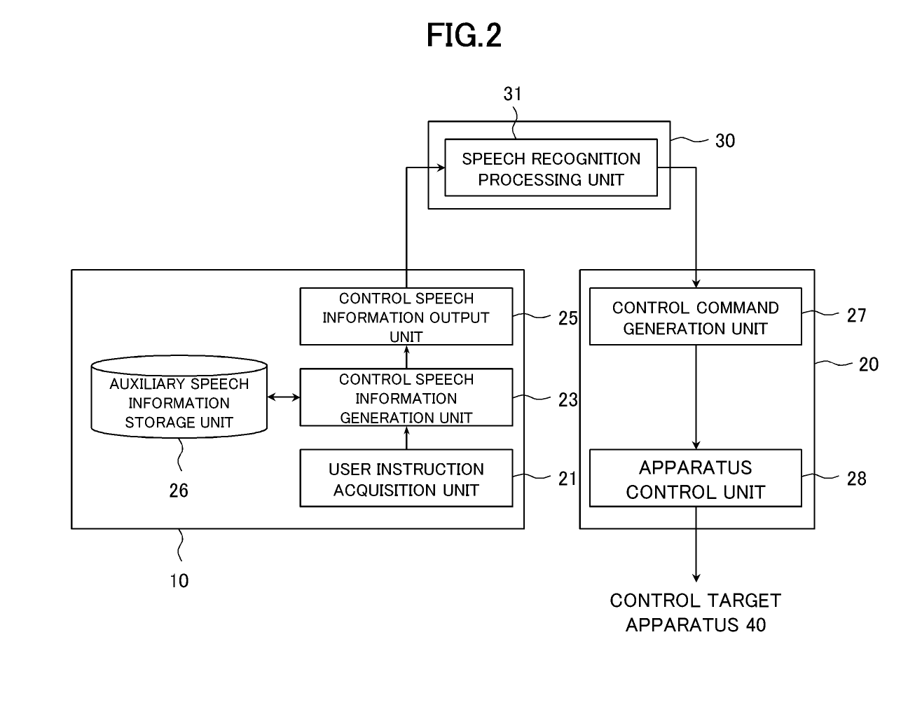

FIG. 2 is a functional block diagram showing an example of functions executed by the first control device 10, the second control device 20, and the speech recognition server 30 according to the first embodiment. As shown in FIG. 2, the first control device 10 according to the first embodiment includes, as its functions, a user instruction acquisition unit 21, a control speech information generation unit 23, a control speech information output unit 25, and an auxiliary speech information storage unit 26. These functions are implemented by the control unit executing a program stored in the storage unit of the first control device 10. The program may be stored in various computer-readable information storage media such as an optical disk and provided in this form, or may be provided via a communication network. The auxiliary speech information storage unit 26 is implemented by the storage unit of the first control device 10. The auxiliary speech information storage unit 26 may also be implemented by an external storage device.

The second control device 20 according to the first embodiment includes, as its functions, a control command generation unit 27 and an apparatus control unit 28. These functions are implemented by the control unit executing a program stored in the storage unit of the second control device 20. The program may be stored in various computer-readable information storage media such as an optical disk and provided in this form, or may be provided via a communication network.

The speech recognition server 30 according to the first embodiment includes a speech recognition processing unit 31 as its function. This function is implemented by the control unit executing a program stored in the storage unit of the speech recognition server 30. The program may be stored in various computer-readable information storage media such as an optical disk and provided in this form, or may be provided via a communication network.

The user instruction acquisition unit 21 of the first control device 10 acquires a user instruction by the user. Specifically, the user instruction acquisition unit 21 acquires a user instruction to control the control target apparatus 40 by the user. In the first embodiment, the user speaks to the sound collection unit of the first control device 10, thus causing the user instruction acquisition unit 21 to acquire the speech uttered by the user (hereinafter referred to as uttered speech information), as a user instruction. In the description below, it is assumed that the user instruction in the first embodiment is uttered speech information.

The control speech information generation unit 23 of the first control device 10 generates control speech information which is speech information representing the content of control on the control target apparatus 40, in response to the user instruction acquired by the user instruction acquisition unit 21. Specifically, as the user instruction acquisition unit 21 acquires a user instruction, this causes the control speech information generation unit 23 to generate control speech information representing the content of control on the control target apparatus 40. The control speech information is made up of speech information which can be processed by speech recognition processing and includes auxiliary speech information which is different information from the user instruction. The auxiliary speech information is stored in advance in the auxiliary speech information storage unit 26. Also, predetermined auxiliary speech information may be generated every time the user instruction acquisition unit 21 acquires a user instruction.

Generally, in order to control the control target apparatus 40 via speech recognition, the user needs to give a user instruction including information specifying a control target apparatus 40 and information indicating an operation of the control target apparatus 40. Therefore, for example, if the user wishes to play back a play list 1 with an audio apparatus located in the living room, the user is to utter “Play back play list 1 in living room”. In this example, “in living room” is the information specifying a control target apparatus 40. “Play back play list 1” is the information indicating an operation of the control target apparatus 40. If the user can omit the utterance of “in living room” in the case where the user always uses the audio apparatus located in the living room, or if the user can omit the utterance of “play list 1” in the case where the user always plays back the play list 1, this improves convenience for the user. In this way, if at least a part of the user instruction can be omitted, this improves convenience for the user. To this end, the first embodiment is configured to be able to omit a part of the user instruction. The following description is about the case where the user omits the utterance of the information specifying a control target apparatus 40 such as “in living room”, as an example. However, the same configuration can also be applied to the case where the user omits the utterance of the information indicating an operation of the control target apparatus 40.

To enable omission of a part of the user instruction, the control speech information generation unit 23 of the first control device 10 according to the first embodiment generates control speech information made up of uttered speech information with auxiliary speech information added. The auxiliary speech information is speech information stored in advance in the auxiliary speech information storage unit 26. The control speech information generation unit 23 acquires the auxiliary speech information from the auxiliary speech information storage unit 26 and adds the acquired auxiliary speech information to the uttered speech information. The auxiliary speech information stored in advance in the auxiliary speech information storage unit 26 may be speech information uttered in advance by the user or may be speech information generated in advance by speech synthesis. For example, if the user omits the utterance of the information specifying a control target apparatus 40, speech information specifying a control target apparatus 40 (in this example, “in living room”) is stored in an advance in the auxiliary speech information storage unit 26 as the auxiliary speech information. Then, when the user utters “play back play list 1”, the control speech information “play back play list 1 in living room” is generated, which is made up of the uttered speech information “play back play list 1” with the auxiliary speech information “in living room” added. That is, the information specifying a control target apparatus 40, of which the user omits utterance, is added as the auxiliary speech information to the uttered speech information.

In this example, place information indicating the place where the control target apparatus 40 is installed, such as “in living room”, is used as the auxiliary speech information. However, this example is not limiting and any information that can univocally specify the control target apparatus 40 may be used. For example, identification information (MAC address, apparatus number or the like) that can univocally identify the control target apparatus 40, or user information indicating the owner of the control target apparatus 40 may be used.

A plurality of pieces of auxiliary speech information may be stored in the auxiliary speech information storage unit 26. Specifically, a plurality of pieces of auxiliary speech information corresponding to each of a plurality of users may be stored. In this case, the control speech information generation unit 23 may specify the user who has given a user instruction, and may acquire the auxiliary speech information corresponding to the specified user. As a method for specifying the user, it is possible specify the user by speech recognition of the uttered speech information, or to specify the user by making the user log in to the system.

The auxiliary speech information is not limited to the example where the auxiliary speech information is stored in advance in the auxiliary speech information storage unit 26. The control speech information generation unit 23 may generate the auxiliary speech information by speech synthesis in response to a user instruction. In this case, the auxiliary speech information generated in response to a user instruction is determined in advance. In the case of the foregoing example, when a user instruction is acquired, the control speech information generation unit 23 generates the auxiliary speech information “in living room”. Also, the control speech information generation unit 23 may specify the user who has given a user instruction, and may generate auxiliary speech information corresponding to the specified user.

The control speech information output unit 25 of the first control device 10 outputs the control speech information generated by the control speech information generation unit 23 to the speech recognition server 30, which executes speech recognition processing.

The speech recognition processing unit 31 of the speech recognition server 30 executes speech recognition processing on the control speech information outputted from the first control device 10. The speech recognition processing unit 31 then outputs the result of recognition in the executed speech recognition processing to the second control device 20. Here, the result of recognition is text information made up of the control speech information converted into a character string by speech recognition. The result of recognition is not limited to text information and may be any form of information whose content can be recognized by the second control device 20.

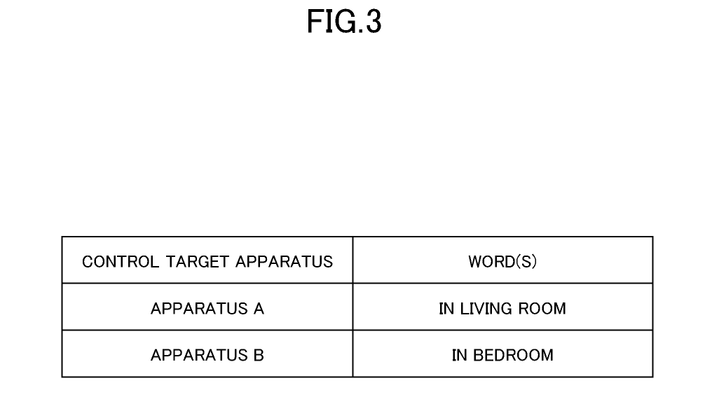

The control command generation unit 27 of the second control device 20 specifies the control target apparatus 40 and the content of control, based on the result of recognition in the speech recognition executed by the speech recognition server 30. The control command generation unit 27 then generates a control command to cause the specified control target apparatus 40 to operate according to the specified content of control. The control command is generated in a format that can be processed by the specified control target apparatus 40. For example, the control target apparatus 40 and the content of control are specified based on a recognition character string “play back play list 1 in living room” acquired through speech recognition of the control speech information “play back play list 1 in living room”. Here, it is assumed that association information which associates a word/words (place, apparatus number, user name or the like) corresponding to each control target apparatus 40 with the control target apparatus 40 is stored in advance in the second control device 20. FIG. 3 shows an example of the association information according to the first embodiment. The control command generation unit 27 refers to the association information as shown in FIG. 3 and thus can specify the control target apparatus 40, based on a word/words included in the recognition character string. For example, the control command generation unit 27 can specify the apparatus A, based on the words “in living room” included in the recognition character string. The control command generation unit 27 can also specify the content of control based on the recognition character string, using known natural language processing.

The apparatus control unit 28 of the second control device 20 controls the control target apparatus 40 according to a control command. Specifically, the apparatus control unit 28 transmits a control command to the specified control target apparatus 40. The control target apparatus 40 then executes processing according to the control command transmitted from the second control device 20. The control target apparatus 40 may transmit a control command acquisition request to the second control device 20. Then, the second control device 20 may transmit a control command to the control target apparatus 40 in response to the acquisition request.

The speech recognition server 30 may specify the control target apparatus 40 and the content of control by speech recognition processing and may output the specified information as the result of recognition to the second control device 20.

In the first embodiment, since the speech recognition server 30 carries out speech recognition, the first control device 10 cannot grasp specific content of a user instruction at the point of acquiring the user instruction. Therefore, the control speech information generation unit 23 simply adds predetermined auxiliary speech information to uttered speech information, whatever content the user utters. For example, if the user utters “play back play list 1 in bedroom”, the control speech information generation unit 23 adds the auxiliary speech information “in living room” to the uttered speech information “play back play list 1 in bedroom” and thus generates “play back play list 1 in bedroom in living room”. Analyzing such a recognition character string obtained by speech recognition of control speech information results in a plurality of control target apparatuses 40 being specified as control targets. Therefore, whether to playback with the apparatus B in the bedroom or with the apparatus A in the living room cannot be determined. Thus, to enable specification of one control target apparatus 40 even if a plurality of control target apparatuses 40 are specified as control targets, the position to add auxiliary speech information to uttered speech information is defined. Specifically, the control speech information generation unit 23 adds auxiliary speech information to the beginning or end of uttered speech information. If the control speech information generation unit 23 adds auxiliary speech information to the end of uttered speech information, the control command generation unit 27 specifies a control target apparatus 40, based on a word/words corresponding to the control target apparatus 40 that appears first in a recognition character string obtained by speech recognition of control speech information. Meanwhile, if the control speech information generation unit 23 adds auxiliary speech information to the beginning of uttered speech information, the control command generation unit 27 specifies a control target apparatus 40, based on a word/words corresponding to the control target apparatus 40 that appears last in a recognition character string obtained by speech recognition of control speech information. This enables specification of one control target apparatus 40 even if a plurality of control target apparatuses 40 are specified as control targets. Also, a control target apparatus 40 can be specified, giving priority to the content uttered by the user.

Alternatively, if the control speech information generation unit 23 adds auxiliary speech information to the end of uttered speech information, the control command generation unit 27 may specify, as a control target, the control target apparatus 40 based on a word/words that appears last in a recognition character string obtained by speech recognition of control speech information. Meanwhile, if the control speech information generation unit 23 adds auxiliary speech information to the beginning of uttered speech information, the control command generation unit 27 may specify, as a control target, the control target apparatus 40 based on a word/words that appears first in a recognition character string obtained by speech recognition of control speech information. Thus, a control target apparatus 40 can be specified, giving priority to the content of the auxiliary speech information.

The first control device 10 may be able to carry out speech recognition of uttered speech information. In this case, the control speech information generation unit 23 may include a determination unit which determines whether the uttered speech information includes information that can specify a control target apparatus 40 or not, by carrying out speech recognition of the uttered speech information. If it is determined that the uttered speech information does not include information that can specify a control target apparatus 40, the control speech information generation unit 23 may add auxiliary speech information to the uttered speech information and thus generate control speech information. This can prevent a plurality of control target apparatuses 40 from being specified as control targets in the analysis of a recognition character string obtained by speech recognition of control speech information.

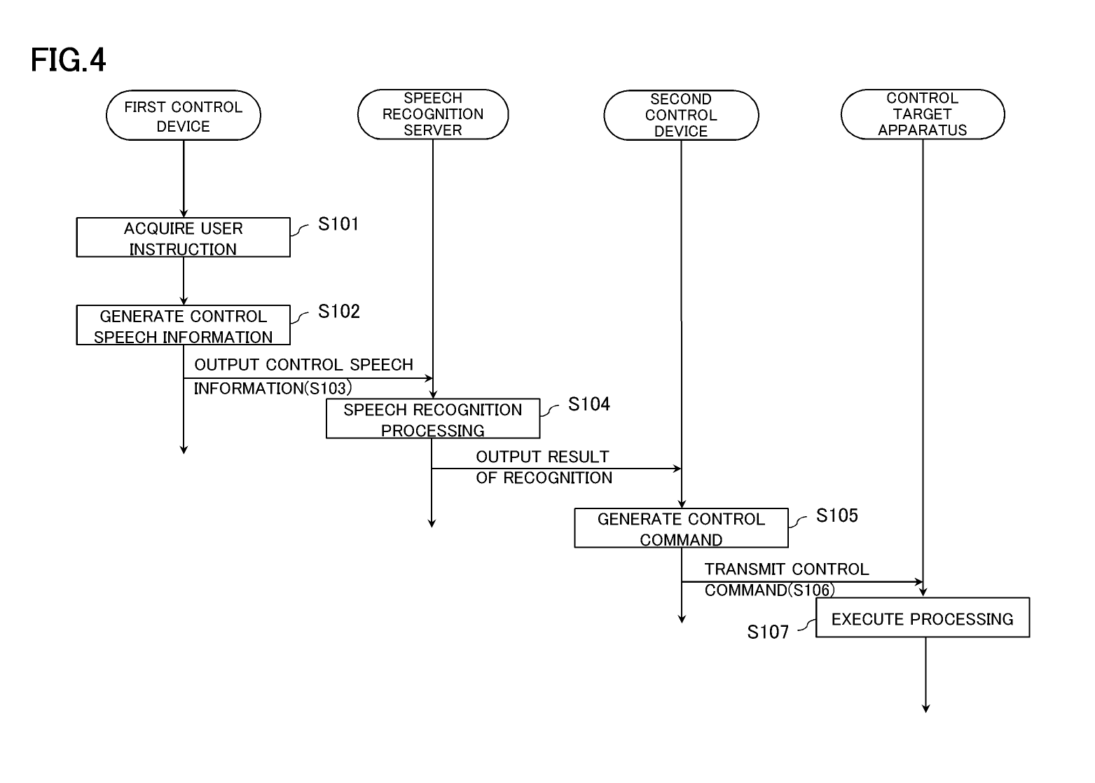

An example of processing executed by the apparatus control system 1 will now be described with reference to the sequence chart of FIG. 4.

The user instruction acquisition unit 21 of the first control device 10 acquires a user instruction from the user (in the first embodiment, uttered speech information) (S101).

The control speech information generation unit 23 of the first control device 10 generates control speech information in response to the user instruction acquired in step S101 (S102). In the first embodiment, the control speech information generation unit 23 generates control speech information made up of the uttered speech information acquired in step S101 with auxiliary speech information added.

The control speech information output unit 25 of the first control device 10 outputs the control speech information generated in step S102 to the speech recognition server 30 (S103).

The speech recognition processing unit 31 of the speech recognition server 30 executes speech recognition processing on the control speech information outputted from the first control device 10 and outputs the result of the recognition to the second control device 20 (S104).

The control command generation unit 27 of the second control device 20 specifies a control target apparatus 40 to be a control target, based on the result of the recognition outputted from the speech recognition server 30, and generates a control command to cause the control target apparatus 40 to operate (S105).

The apparatus control unit 28 of the second control device 20 transmits the control command generated in step S105 to the specified control target apparatus 40 (S106).

The control target apparatus 40 executes processing according to the control command transmitted from the second control device (S107).

### Second Embodiment

In a second embodiment, the case where the user instruction acquisition unit 21 accepts an operation on the operation unit by the user, as a user instruction, will be described. The overall configuration of the apparatus control system 1 according to the second embodiment is the same as the configuration according to the first embodiment shown in FIG. 1 and therefore will not be described repeatedly.

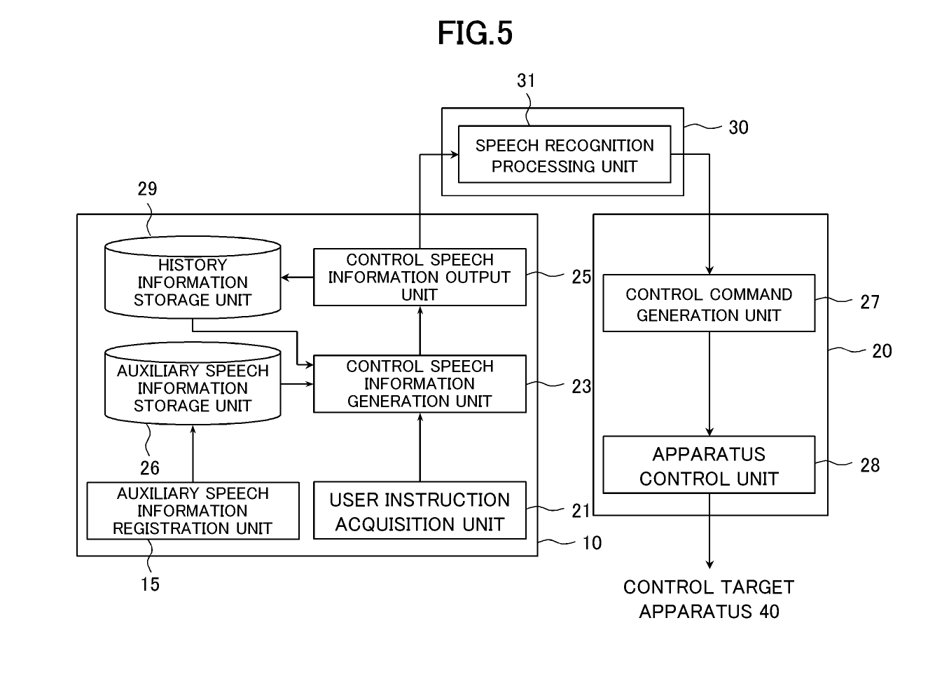

FIG. 5 is a functional block diagram showing an example of functions executed by the first control device 10, the second control device 20, and the speech recognition server 30 according to a first example of the second embodiment. The functional block according to the first example of the second embodiment is the same as the functional block according to the first embodiment shown in FIG. 2, except that the configuration of the first control device is different. Therefore, the same components of the configuration as in the first embodiment are denoted by the same reference signs and are not described repeatedly.

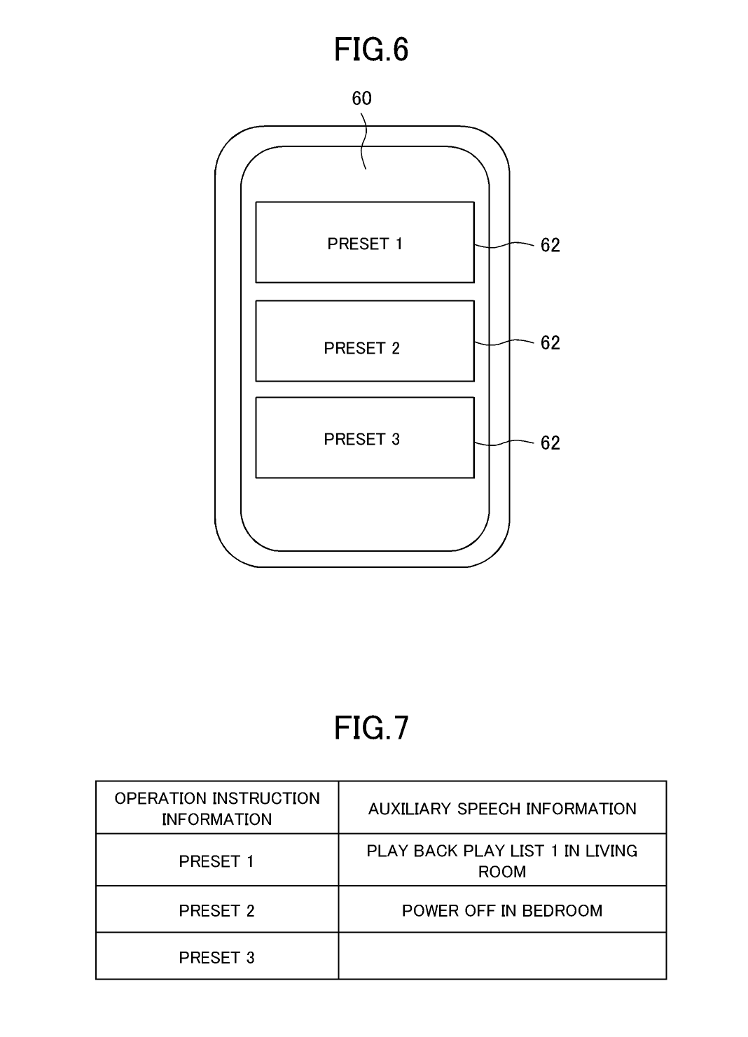

In the first example of the second embodiment, the user carries out an operation on the operation unit of the first control device 10, thus causing the user instruction acquisition unit 21 to accept information representing the operation on the operation unit by the user (hereinafter referred to as operation instruction information), as a user instruction. In the description below, the user instruction in the second embodiment is referred to as operation instruction information. For example, if one or more buttons are provided as the operation unit of the first control device 10, the user presses one of the buttons, thus causing the user instruction acquisition unit 21 to accept operation instruction information indicating the pressed button. The operation unit of the first control device 10 is not limited to buttons and may also be a touch panel provided on the display unit. Alternatively, the user may remotely operate the first control device 10, using a mobile apparatus (for example, a smartphone) that is separate from the first control device 10. In this case, the smartphone executes an application, thus causing an operation instruction screen 60 to be displayed on the display unit, as shown in FIG. 6. FIG. 6 shows an example of the operation instruction screen 60 displayed on the display unit of the first control device 10. The operation instruction screen 60 includes item images 62 to accept an operation by the user (for example, preset 1, preset 2, preset 3). The item images 62 are associated with the buttons on the first control device 10. The user carries out an operation such as a tap on one of the item images 62, thus causing the user instruction acquisition unit 21 to accept operation instruction information indicating the item image 62 of the operation target. If the first control device 10 is a device having a display (for example, a smartphone), the user may carry out an operation using the operation instruction screen 60 as shown in FIG. 6.

In the first example of the second embodiment, the control speech information generation unit 23 generates control speech information, based on auxiliary speech information stored in advance in the storage unit in association with the operation instruction information. FIG. 7 shows an example of the auxiliary speech information storage unit 26 according to the second embodiment. In the auxiliary speech information storage unit 26, operation instruction information and auxiliary speech information are managed in association with each other, as shown in FIG. 7. The control speech information generation unit 23 acquires the auxiliary speech information associated with the operation instruction information acquired by the user instruction acquisition unit 21, from the auxiliary speech information storage unit 26 shown in FIG. 7, and generates control speech information. In other words, the control speech information generation unit 23 uses the auxiliary speech information associated with the operation instruction information acquired by the user instruction acquisition unit 21, as control speech information. The control speech information generation unit 23 may generate control speech information by playing back and re-recording the auxiliary speech information associated with the operation instruction information. In this way, the control speech information generation unit 23 uses the auxiliary speech information stored in advance without any change as control speech information. This enables apparatus control based on speech recognition using the speech recognition server 30 without the user having to utter anything.

In FIG. 5, the auxiliary speech information is stored in the auxiliary speech information storage unit 26 of the first control device 10. However, this example is not limiting. The auxiliary speech information may be stored in a mobile apparatus (for example, a smartphone) that is separate from the first control device 10. If the auxiliary speech information is stored in a mobile apparatus, the auxiliary speech information may be transmitted from the mobile apparatus to the first control device 10, and the auxiliary speech information received by the first control device 10 may be outputted to the speech recognition server 30 as control speech information. The auxiliary speech information may also be stored in another cloud server. Even in the case where the auxiliary speech information is stored in another cloud server, the first control device 10 may acquire the auxiliary speech information from the cloud server and output the auxiliary speech information to the speech recognition server 30.

The control speech information output unit 25 of the first control device 10 outputs the control speech information generated by the control speech information generation unit 23 to the speech recognition server 30, which executes speech recognition processing. In the second embodiment, the first control device 10 holds the speech information represented by the control speech information outputted from the control speech information output unit 25, in a history information storage unit 29. The first control device 10 holds the speech information represented by the control speech information in association with the time when the control speech information is outputted, and thus generates history information representing a history of use of the control speech information. Of the control speech information outputted from the control speech information output unit 25, control speech information on which speech recognition processing is successfully carried out by the speech recognition processing unit 31 of the speech recognition server 30 may be held as history information. This makes it possible to hold only the speech information on which speech recognition processing is successfully carried out, as history information.

Here, the control speech information generation unit 23 of the first control device 10 may generate control speech information based on the speech information held as the history information. For example, history information may be displayed on a display unit such as a smartphone, and the user may select a piece of the history information. Thus, the user instruction acquisition unit 21 of the first control device 10 may acquire the selected history information as operation instruction information. Then, the control speech information generation unit 23 of the first control device 10 may acquire speech information corresponding to the history information selected by the user, from the history information storage unit 29, and thus generate control speech information. As the control speech information is generated from the history information, the speech information on which speech recognition processing has successfully been carried out can be used as the control speech information. This makes the speech recognition processing less likely to fail.

The auxiliary speech information managed in the auxiliary speech information storage unit 26 shown in FIG. 7 is registered by an auxiliary speech information registration unit 15 of the first control device 10. Specifically, the auxiliary speech information registration unit 15 registers the auxiliary speech information in association with a button provided on the first control device 10. If a plurality of buttons is provided, the auxiliary speech information registration unit 15 registers the auxiliary speech information in association with each of the plurality of buttons. For example, the user long-presses a button on the first control device 10 and utters content of control to be registered on the button. This causes the auxiliary speech information registration unit 15 to register information indicating the button (for example, preset 1) in association with speech information representing the uttered content of control (for example, “play back play list 1 in living room”), in the auxiliary speech information storage unit 26. If auxiliary speech information is already associated with the preset 1, the auxiliary speech information registration unit 15 registers the latest auxiliary speech information by overwriting. Also, the user may long-press a button on the first control device 10 to call history information. The user may then select speech information from the history information, thus causing the auxiliary speech information registration unit 15 to register information indicating the button in association with the speech information selected from the history information, in the auxiliary speech information storage unit 26. Moreover, auxiliary speech information may be registered in association with a button provided on the first control device 10, using a mobile apparatus (smartphone or the like) which is separate from the first control device 10 and which can communicate with the first control device 10.

The auxiliary speech information registration unit 15 may also register auxiliary speech information from history information. Specifically, the user may select speech information to be registered, referring to history information, and then select operation instruction information to be associated with the speech information, thus causing the auxiliary speech information registration unit 15 to register the operation instruction information in association with the speech information selected from the history information, in the auxiliary speech information storage unit 26.

If the user remotely operates the first control device 10 via a smartphone or the like, or if the first control device 10 is a smartphone or the like, registration can be made on an application executed by the smartphone. For example, the user long-presses an item image on the operation instruction screen shown in FIG. 6 and utters content of control to be registered on the item image. This causes the auxiliary speech information registration unit 15 to register information indicating the item image (for example, preset 2) in association with speech information representing the uttered content of control (for example, “power off in bedroom”), in the auxiliary speech information storage unit 26. If auxiliary speech information is already associated with the preset 2, the auxiliary speech information registration unit 15 registers the latest auxiliary speech information by overwriting. Also, the user may long-press an item image to call history information. The user may then select speech information from the history information, thus causing the auxiliary speech information registration unit 15 to register information indicating the item image in association with the speech information selected from the history information, in the auxiliary speech information storage unit 26. Moreover, the user can arbitrarily change the names of the item images (preset 1, preset 2, preset 3) on the operation instruction screen shown in FIG. 6. When changing any of the names, the user may have the registered speech information played back and listen to and check the content played back.

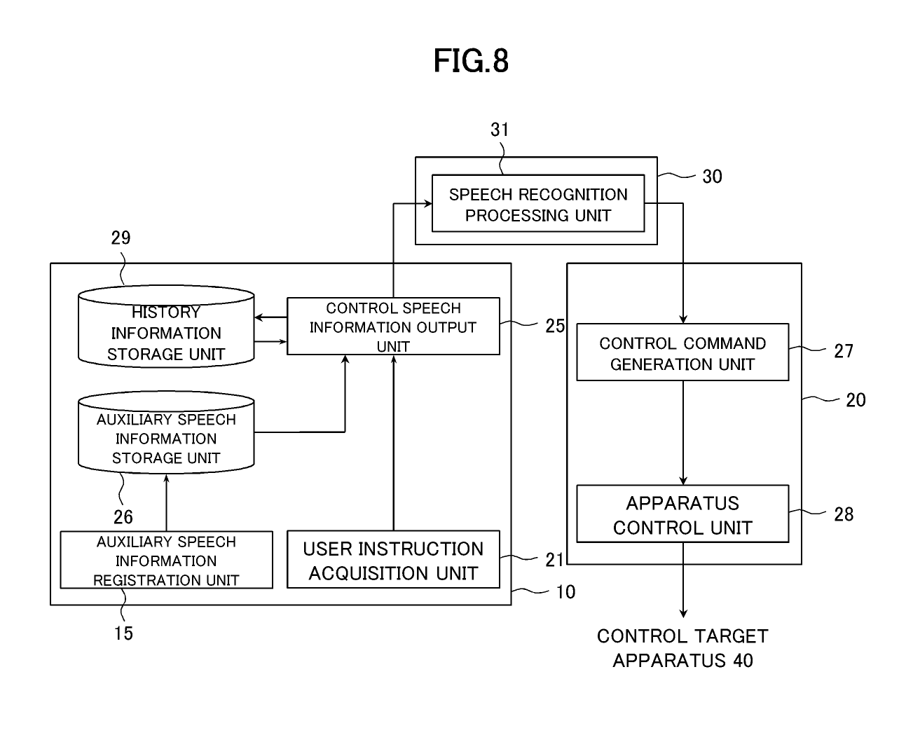

Next, in a second example of the second embodiment, the first control device 10 does not include the control speech information generation unit 23. FIG. 8 is a functional block diagram showing an example of functions executed by the first control device 10, the second control device 20, and the speech recognition server 30 according to the second example of the second embodiment. The functional block diagram according to the second example of the second embodiment is the same as the functional block diagram according to the first example of the second embodiment shown in FIG. 5, except that the configuration of the first control device is different. Therefore, the same components of the configuration as in the first example of the second embodiment are denoted by the same reference signs and are not described repeatedly.

In the second example of the second embodiment, the control speech information output unit 25 of the first control device 10 acquires, from the auxiliary speech information storage unit 26, auxiliary speech information associated with operation instruction information acquired by the user instruction acquisition unit 21. The control speech information output unit 25 then outputs the auxiliary speech information acquired from the auxiliary speech information storage unit 26, to the speech recognition server 30. That is, the control speech information output unit 25 outputs the auxiliary speech information stored in the auxiliary speech information storage unit 26 without any change as control speech information to the speech recognition server 30. The control speech information output unit 25 may also output speech information acquired from the history information storage unit 29 without any change as control speech information to the speech recognition server 30. In this way, the control speech information output unit 25 outputs the auxiliary speech information stored in advance without any change as control speech information. This enables apparatus control based on speech recognition using the speech recognition server 30 without the user having to utter anything.

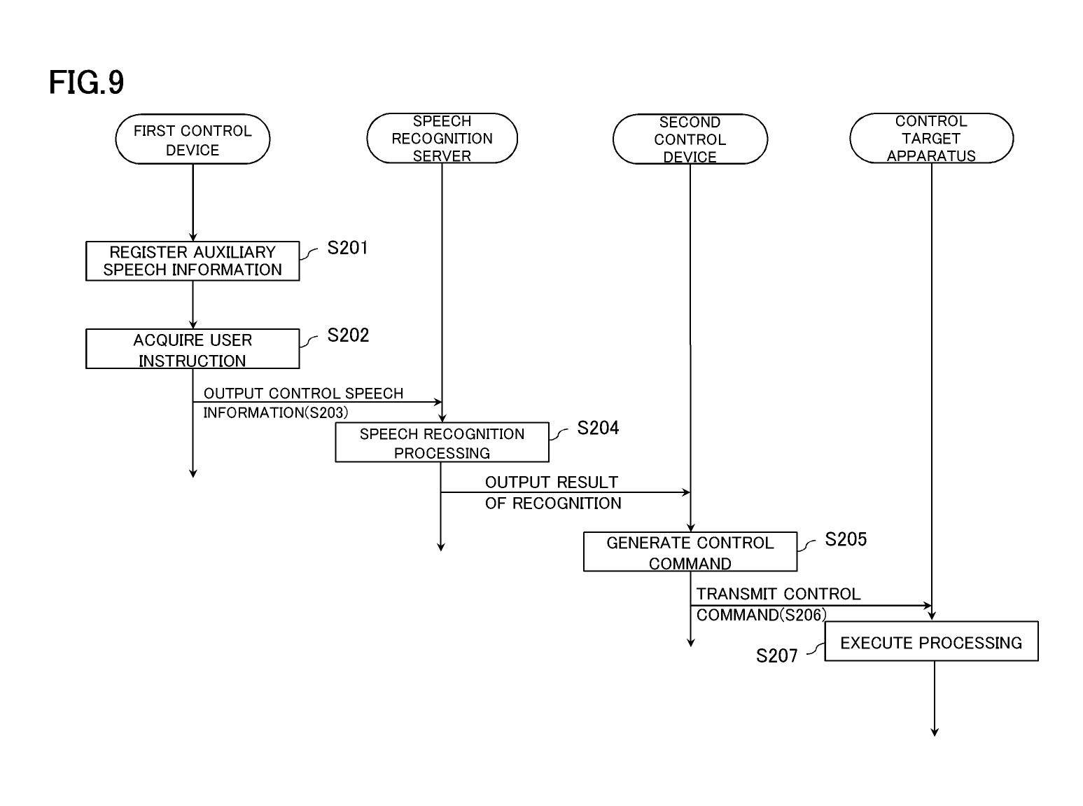

An example of processing executed by the apparatus control system 1 according to the second example of the second embodiment will now be described with reference to the sequence chart of FIG. 9.

The auxiliary speech information registration unit 15 of the first control device 10 registers auxiliary speech information in the auxiliary speech information storage unit 26 (S201).

The user instruction acquisition unit 21 of the first control device 10 acquires a user instruction from the user (in the second embodiment, operation instruction information) (S202).

The control speech information output unit 25 of the first control device 10 acquires auxiliary speech information corresponding to the operation instruction information acquired in step S202, from the auxiliary speech information storage unit 26, and outputs the auxiliary speech information to the speech recognition server 30 (S203).

The speech recognition processing unit 31 of the speech recognition server 30 executes speech recognition processing on the control speech information outputted from the first control device 10 and outputs the result of the recognition to the second control device 20 (S204).

The control command generation unit 27 of the second control device 20 specifies a control target apparatus 40 to be a control target, based on the result of the recognition outputted from the speech recognition server 30, and generates a control command to cause the control target apparatus 40 to operate (S205).

The apparatus control unit 28 of the second control device 20 transmits the control command generated in step S205 to the specified control target apparatus 40 (S206).

The control target apparatus 40 executes processing according to the control command transmitted from the second control device (S207).

In the second embodiment, auxiliary speech information is thus registered in advance in association with operation instruction information such as the operation unit of the first control device 10, and an item image of an application. This enables the user to control the control target apparatus 40 simply by operating a button and without uttering anything. Thus, apparatus control based on speech recognition using the speech recognition server can be executed even in an environment with many noises, an environment where the user cannot speak aloud, or in the case where the control target apparatus 40 is located at a distance.

Particularly, in the case of controlling a different apparatus from the first control device 10 via the second control device 20 and the speech recognition server 30, as are cloud servers, or in the case of performing timer control or control with a fixed schedule, it is effective to use pre-registered auxiliary speech information for the control. In the case of controlling an apparatus via the second control device 20 and the speech recognition server 30, a control command is transmitted only to the target apparatus from the second control device 20. The first control device 10 cannot hold a control command for a different apparatus from itself. Therefore, in the case of controlling, from the first control device 10, a different apparatus from the first control device 10, control using a control command cannot be carried out. Thus, it is effective to use registered auxiliary speech information for the control.

In the case of timer control or control with a fixed schedule, a complex control instruction is given. Therefore, it is effective to use registered auxiliary speech information for the control. For example, it is difficult for the first control device 10 to output, as one control command, a user instruction (user instruction with a fixed schedule) including information indicating a plurality of operations associated with time information such as “turn off the room light, then turn on the television 30 minutes later, change the channel to channel 2, and gradually increase the volume”. Here, the plurality of operations may be operations in one control target apparatus 40 or may be operations in a plurality of control target apparatuses 40. However, the second control device 20 and the speech recognition server 30 can transmit a control command to each apparatus according to a fixed schedule, by acquiring a user instruction with a fixed schedule as described above as speech information and executing speech recognition processing. Thus, by registering in advance auxiliary speech information which includes information indicating a plurality of operations associated with time information and which represents control with a fixed schedule, it is possible to easily carry out a complex user instruction that cannot otherwise be given from the first control device 10.

It is also difficult for the first control device 10 to output, as a control command, a user instruction to designate a function of the second control device 20 or the speech recognition server (for example, “play back music corresponding to weather”). Therefore, it is effective to register such a user instruction in advance as auxiliary speech information.

The user can register even a complex control instruction as auxiliary speech information simply by uttering the instruction. This is very convenient for the user. The user can also check the content of control simply by playing back the registered auxiliary speech information. This is more convenient for the user than a control command the content of which is difficult to display.

The invention is not limited to the foregoing embodiments.

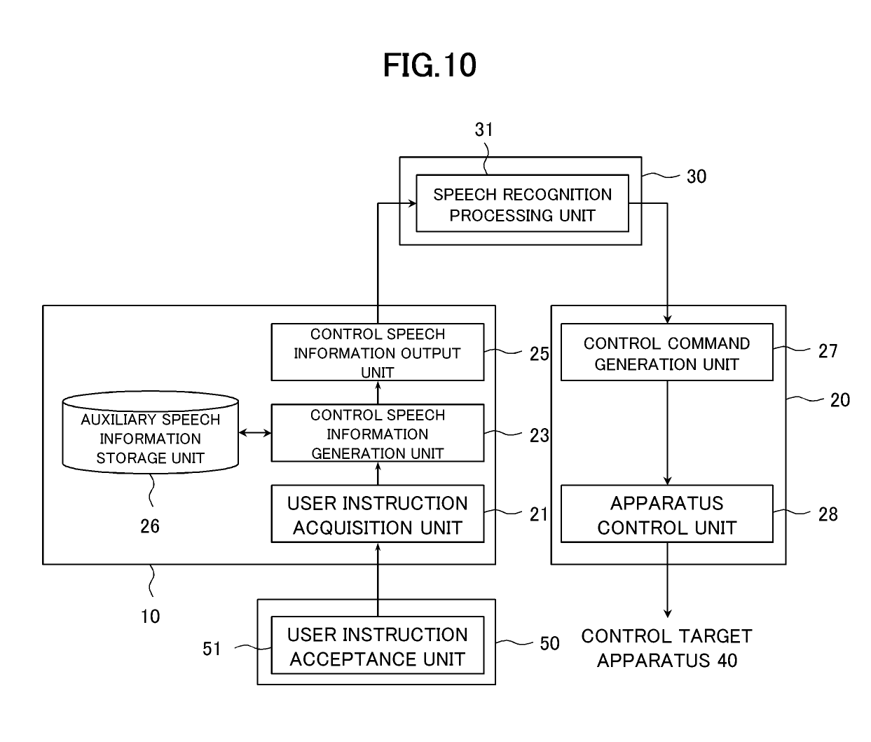

For example, in the first embodiment, the first control device 10 may be implemented as a local server or cloud server. In this case, an acceptance device 50 which is separate from the first control device 10 and accepts a user instruction is used. FIG. 10 is a functional block diagram showing an example of functions executed by the first control device 10, the second control device 20, and the speech recognition server 30 according to the first embodiment, and the acceptance device 50. As shown in FIG. 10, the acceptance device 50 includes a user instruction acceptance unit 51 which accepts a user instruction from the user. The user instruction acceptance unit 51 accepts a user instruction from the user and transmits the user instruction to the first control device 10. The user instruction acquisition unit 21 of the first control device 10 acquires the user instruction transmitted from the acceptance device 50.

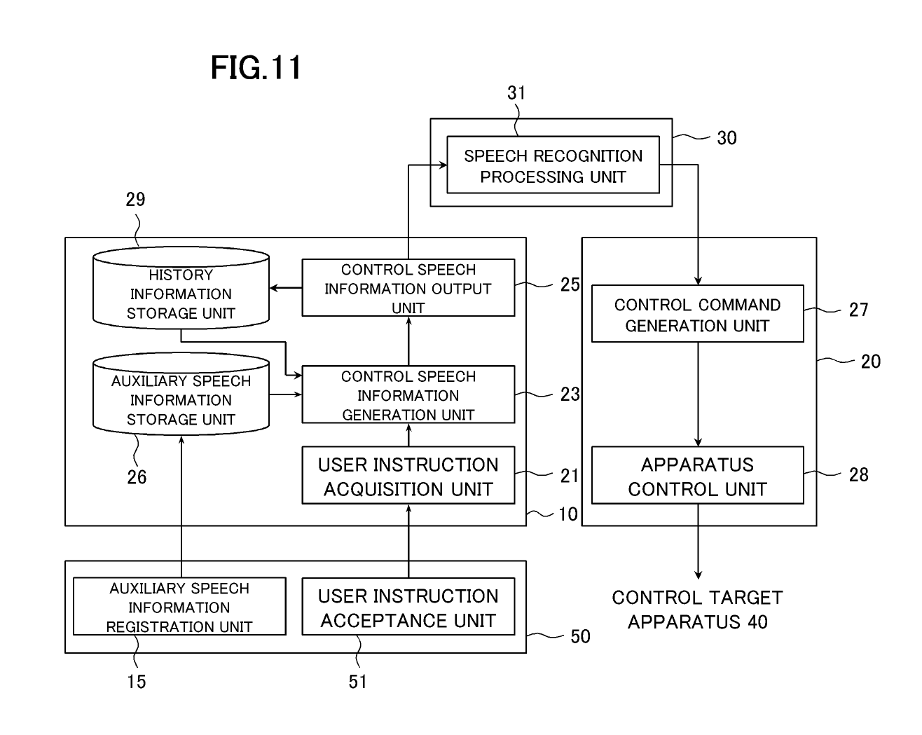

In the second embodiment, the first control device 10 may be implemented as a local server or cloud server. In this case, an acceptance device 50 which is separate from the first control device 10 and accepts a user instruction is used. FIG. 11 is a functional block diagram showing an example of functions executed by the first control device 10, the second control device 20, and the speech recognition server 30 according to the second embodiment, and the acceptance device 50. As shown in FIG. 11, the acceptance device 50 includes a user instruction acceptance unit 51 which accepts a user instruction from the user, and the auxiliary speech information registration unit 15. The user instruction acceptance unit 51 accepts a user instruction from the user and transmits the user instruction to the first control device 10. The user instruction acquisition unit 21 of the first control device 10 acquires the user instruction transmitted from the acceptance device 50.

In the first embodiment and the second embodiment, an example where the second control device 20 and the speech recognition server 30 are separate units is described. However, the second control device 20 and the speech recognition server 30 may be integrated into one device.

In the first embodiment, the information specifying a control target apparatus 40 and the information indicating an operation of the control target apparatus 40 are used as auxiliary speech information. However, this example is not limiting. For example, auxiliary speech information may be angle information indicating the direction in which the user speaks, or user identification information to identify the user, or the like. If control speech information with angle information added indicating the direction in which the user speaks is generated, the control target apparatus 40 can be controlled, based on the angle information. For example, a speaker provided in the control target apparatus 40 can be directed in the direction in which the user speaks, based on the angle information. If control speech information with user identification information added is generated, the control target apparatus 40 can be controlled according to the result of speech recognition of the user identification information. For example, if user identification based on the user identification information is successful, the user name with which the user identification is successful can be displayed on the control target apparatus 40, or an LED can be turned on to show that the user identification is successful.

While there have been described what are at present considered to be certain embodiments of the invention, it will be understood that various modifications may be made thereto, and it is intended that the appended claims cover all such modifications as fall within the true spirit and scope of the invention.

1. A control method for a control device, the method comprising:
acquiring a user instruction to control a control target apparatus by a user;
generating control speech information in response to the user instruction, the control speech information being speech information representing content of control on the control target apparatus and including auxiliary speech information which is different information from the user instruction; and
outputting the generated control speech information to a speech recognition server which executes speech recognition processing.

2. The control method for the control device according to claim 1, wherein
the user instruction is uttered speech information which is a speech uttered by the user, and
the generating the control speech information includes generating the control speech information made up of the uttered speech information with the auxiliary speech information added.

3. The control method for the control device according to claim 2, wherein
the generating the control speech information includes generating the control speech information by adding the auxiliary speech information to the beginning or end of the uttered speech information.

4. The control method for the control device according to claim 2, further comprising
determining whether the uttered speech information includes information that can specify the control target apparatus or not,
wherein if, in the determining, it is determined that the uttered speech information does not include information that can specify the control target apparatus, the generating the control speech information includes generating the control speech information made up of the uttered speech information with the auxiliary speech information added.

5. The control method for the control device according to claim 1, wherein
the auxiliary speech information is information that univocally specifies the control target apparatus.

6. The control method for the control device according to claim 1, wherein
the auxiliary speech information is information indicating an operation of the control target apparatus.

7. The control method for the control device according to claim 1, wherein
the user instruction is operation instruction information indicating an operation on an operation unit by the user, and
the generating the control speech information includes generating the control speech information based on the auxiliary speech information stored in advance in a storage unit, corresponding to the operation instruction information.

8. The control method for the control device according to claim 7, further comprising
registering the operation instruction information and the auxiliary speech information in association with each other in the storage unit.

9. The control method for the control device according to claim 7, further comprising
accessing a history information storage unit which holds speech information representing the control speech information outputted,
wherein the control speech information is generated based on the speech information held in the history information storage unit.

10. The control method for the control device according to claim 7, wherein
the auxiliary speech information includes information indicating a plurality of operations associated with time information.

11. The control method for the control device according to claim 1, further comprising
controlling the control target apparatus according to a control command obtained by having speech recognition processing carried out on the control speech information.

12. The control method for the control device according to claim 1, wherein
the control target apparatus is an audio apparatus.

13. A control method for the apparatus control system comprising:
acquiring a user instruction to control a control target apparatus by a user;
generating control speech information in response to the user instruction, the control speech information being speech information representing content of control on the control target apparatus and including auxiliary speech information which is different information from the user instruction;
outputting the generated control speech information to a speech recognition server which executes speech recognition processing;
generating a control command to cause the control target apparatus to operate, based on a result of recognition in the speech recognition processing executed by the speech recognition server; and
controlling the control target apparatus according to the control command.

14. A control device comprising:
a user instruction acquisition unit which acquires a user instruction to control a control target apparatus by a user;
a control speech information generation unit which generates control speech information in response to the user instruction, the control speech information being speech information representing content of control on the control target apparatus and including auxiliary speech information which is different information from the user instruction; and
a control speech information output unit which outputs the generated control speech information to a speech recognition server which executes speech recognition processing.

15. The control device according to claim 14, wherein
the user instruction is uttered speech information which is a speech uttered by the user, and
the control speech information generation unit generates the control speech information made up of the uttered speech information with the auxiliary speech information added.

16. The control device according to claim 15, wherein
the control speech information is generated by adding the auxiliary speech information to the beginning or end of the uttered speech information.

17. The control device according to claim 15, further comprising
a determination unit which determines whether the uttered speech information includes information that can specify the control target apparatus or not,
wherein if the determination unit determines that the uttered speech information does not include information that can specify the control target apparatus, the control speech information generation unit generates the control speech information made up of the uttered speech information with the auxiliary speech information added.

18. The control device according to claim 14, wherein
the auxiliary speech information is information that univocally specifies the control target apparatus.

19. The control device according to claim 14, wherein
the auxiliary speech information is information indicating an operation of the control target apparatus.

20. The control device according to claim 14, wherein
the user instruction is operation instruction information indicating an operation on an operation unit by the user, and
the control speech information generation unit generates the control speech information based on the auxiliary speech information stored in advance in a storage unit, corresponding to the operation instruction information.
